(19) United States
(12) Patent Application Publication
(10) Pub. No.: US 2016/0159571 A1
(43) Pub. Date: Jun. 9, 2016

(54) LIFTER FOR A REFUSE COLLECTION CONTAINER

(71) Applicant: Perkins Manufacturing Co., Romeoville, IL (US)

(72) Inventor: Carlos Arrez, Berwyn, IL (US)

(21) Appl. No.: 14/955,957

(22) Filed: Dec. 1, 2015

Related U.S. Application Data
(60) Provisional application No. 62/088,158, filed on Dec. 5, 2014.

(51) Int. Cl. B65F 3/04; B65F 3/08; B65F 3/02

(52) U.S. Cl. CPC B65F 3/041; B65F 3/02; B65F 3/08; B65F 2003/023; B65F 2003/0276; B65F 2003/0293

(57) ABSTRACT

A refuse receptacle lifter is provided for use with a collection container to receive refuse from a refuse receptacle. The lifter comprises an elongated lift arm with an arcuate upper end and a lower end, with the lift arm being movable relative to the collection container between a first, generally vertically-extending retracted and a second, extended position in which the lower end of the lift arm is spaced away from the collection container. In one embodiment, the lift arm comprises a lower linear portion defining the lower end, with the lower linear portion being angularly disposed relative to an intermediate linear portion so that when the lift arm is in the first, retracted position, the lower end of the lift arm is generally located beneath the arcuate upper end of the lift arm.

### BACKGROUND

Side load refuse collection containers are in wide use in large-scale residential refuse collection. A side load refuse collection vehicle typically has a front cab and a large refuse collection container, compartment or hopper behind the cab that has an upper opening through which refuse is dumped from a residential refuse collection cart into the hopper. A receptacle lifter is typically mounted to the frame of the vehicle or the hopper, for engaging, lifting and inverting a residential collection cart to empty its contents into the hopper, and then returning and releasing the collection cart.

To maximize the volume of refuse that may be dumped into the hopper, the hopper may have relatively high side walls. Consequently, the receptacle lifter has to have a commensurate vertical range of motion to be able to dump the collection cart. The receptacle lifter may also be movable laterally or horizontally away from the collection vehicle, i.e., have an “extended reach,” in order to engage and release collection carts that are placed remotely from the collection vehicle.

Ghibaudo U.S. Pat. No. 5,702,225 discloses an automated “high lifter” for use with a side loading collection vehicle. It includes a lift arm that has a pivotal but non-extendable upper end and an extendable lower end. The lift arm is pivotally supported between its upper and lower ends by a pair of horizontally-extendable support rails that slide beneath the body of the collection vehicle. A carriage that supports opposed refuse collection cart gripper arms is mounted for reciprocation along the lift arm to the curved upper end for dumping refuse from a refuse receptacle into the hopper of the collection vehicle.

The present application is directed to an automated high lifter having features and advantages not found in the prior high-lifting devices such as Ghibaudo.

### SUMMARY OF INVENTION

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto. While shown and described in the context of a refuse collection vehicle, the present subject matter may also find use in other applications and settings.

In accordance with the present disclosure, a refuse receptacle lifter is provided for use with a collection container, for example, a refuse collection vehicle, the collection container including an upper opening to receive refuse from a refuse receptacle. The lifter comprises an elongated lift arm with an arcuate upper end and a lower end, with the lift arm being movable relative to the collection container between a first, generally vertically-extending retracted position in which the lift arm is in proximity to the collection container and a second, extended position in which both the upper and the lower ends of the lift arm are spaced away from the collection container.

A refuse receptacle engagement mechanism is secured to the lift arm for temporarily engaging a refuse receptacle, the engagement mechanism being movable along the lift arm between a first position at the lower end of the lift arm for storage and for engaging and releasing a refuse receptacle and a second position at the upper arcuate end of the lift arm for emptying refuse from a refuse receptacle into the upper opening of the collection container.

In a first aspect, the lifter further comprises a mounting assembly for mounting the lifter in cooperative association with the collection container. A first elongated link arm is pivotally connected on a first end to the mounting assembly and pivotally connected on a second end to the lift arm. A second elongated link arm is pivotally connected on a first end to the mounting assembly at a location below the pivotal connection of the first link arm to the mounting assembly, and is pivotally connected on a second end to the lift arm between the upper and lower ends. An extensible actuator is interposed between the mounting assembly and the lift arm and is pivotally connected on a first end to the mounting assembly and pivotally connected on a second end to the lift arm for moving the lift arm between the first, retracted position and the second, extended position.

Preferably, the first and second link arms are of different lengths, with the first ends of the link arms being spaced apart a first distance and the second ends of the link arms being spaced apart a second distance different from the first distance. It is also preferable that the first end of the actuator be pivotally secured to the mounting assembly intermediate the first ends of the first and second link arms the first end of the actuator is pivotally secured to the mounting assembly intermediate the first ends of the first and second link arms and the second end of the actuator is spaced from the second end of the first link arm a third distance greater than the second distance.

In further keeping with the first aspect, the extensible actuator may comprise an elongated cylinder and piston rod. One of the cylinder and piston rod of the first actuator is pivotally connected to the mounting assembly and the other of the first actuator is pivotally connected to the link arm. Preferably, the actuator is hydraulically powered.

Alternatively, an elongated link arm is provided that is pivotally connected on a first end to the mounting assembly and pivotally connected on a second end to an upper portion of the lift arm. A first actuator is interposed between the mounting assembly and the link arm for pivoting the link arm between retracted and extended positions, and a second actuator is interposed between the mounting assembly and the lift arm for moving the lift arm between the first, retracted position and the second, extended position.

In keeping with a second aspect of the disclosure, the lift arm comprises an upper arcuate portion defining the arcuate upper end, a lower linear portion defining the lower end, and an intermediate linear portion extending between the arcuate upper end and the lower linear portion. The lower linear portion is angularly disposed relative to the intermediate linear portion so that when the lift arm is in the first, retracted position, the lower end of the lift arm is generally located beneath the arcuate upper end of the lift arm. Preferably, the intermediate and lower linear portions of the lift arm are disposed with respect to one another at a relative interior angle of from between about 30° and 60°. More preferably, the interior angle is approximately 40°.

In further keeping with the second aspect, the lifter further may comprise a motor fixedly secured adjacent the upper end of the lift arm for moving the engagement mechanism between the first and second positions. Preferably, the motor is hydraulically powered.

In a third aspect, the engagement mechanism further comprises a carriage movably secured to the lift arm for movement between the lower and upper ends thereof. An engagement mechanism support is provided that is pivotably secured to the carriage. The engagement mechanism is mounted to the support for movement between a first position for receiving and releasing a refuse receptacle and a second position for engaging the refuse receptacle, and an actuator is interposed between the carriage and the engagement mechanism support for pivoting the support relative to the carriage.

Related to this third aspect, the carriage may comprise a pair of arms extending outwardly therefrom, and the engagement mechanism support may comprise a pair of supports, each arm being pivotably connected to a respective support.

Also related to this third aspect, the actuator may comprises a piston and cylinder, with one of the piston and cylinder being pivotably connected to the carriage and the other being pivotably connected to the engagement mechanism support. Preferably, the actuator is hydraulically powered.

In a fourth aspect, the lift arm comprises a track and the engagement mechanism further comprises a carriage movable along the track between the lower and upper ends of the lift arm. The carriage is cooperatively associated with the track by a plurality of links having first and second ends, the first end of each link being pivotably secured to the carriage and the second end of each link carrying a follower received in the track. Sufficient pivotal movement of the links is permitted so that as the carriage moves along the arcuate end of the lift arm, the distance between the followers on adjacent links may vary to allow movement along the arcuate upper end of the lift arm.

Related to this fourth aspect, the followers may comprise wheels mounted to the second end of each link so as to be freely rotatable with respect thereto.

Also related to the fourth aspect, the carriage may comprise opposed side plates, with the first end of each link being pivotably mounted thereto. The side plates have a slot corresponding to each link mounted thereto, with each slot being cooperatively associated with the second end of each link to allow pivoting of the second end of the links relative to the first end. Preferably, each slot is arcuately shaped and has an arcuate extent to permit the pivoting of the links so as to accommodate maximum and minimum distances between adjacent followers as the carriage moves along the lift arm.

Further related to the fourth aspect, the lift arm of the lifter may include an arcuate lower portion that has a different radius of curvature than the arcuate upper end, and the distance between the followers is sufficiently variable to allow movement of the carriage along both the upper arcuate end and the lower arcuate portion.

In a fifth aspect, a lock for selectively securing and releasing the lift arm when in the first, retracted position is provided, the locking mechanism comprising a first part fixed relative to the collection container and selectively engagable with a second part carried by the lift arm when the lift arm is in the first, retracted position.

Related to the fifth aspect, the first part of the locking mechanism may comprise a cylinder and piston, with the piston comprising a rod extending out of the cylinder. The rod has a capturing member thereon for engaging a complementarily-shaped captured member that comprises the second part of the locking mechanism. Preferably, the capturing member comprises a generally U-shaped saddle and the complementarily-shaped second part of the locking mechanism comprises a pin engagable by the saddle. Further, the locking mechanism may be hydraulically actuated.

### BRIEF DESCRIPTION OF THE DRAWINGS

FIG. 1A is a side view of a first embodiment of a refuse receptacle lifter in accordance with the present disclosure shown in conjunction with a refuse collection vehicle, with parts of the refuse collection vehicle broken away to show detail, the lifter being in the retracted position.

FIG. 1B is an enlarged side view of the refuse receptacle lifter of FIG. 1A, separate from the collection vehicle or container.

FIG. 2 is a perspective view of the refuse receptacle lifter of FIG. 1A, separate from the collection vehicle or container.

FIGS. 3A and 3B are a side view and perspective view, respectively, of the refuse receptacle lifter of FIG. 1A in the extended position, with the refuse receptacle engagement mechanism engaging a refuse receptacle.

FIGS. 4A and 4B are a side view and perspective view, respectively, of a second embodiment of a refuse receptacle lifter in the extended position, with the refuse receptacle engagement mechanism engaging a refuse receptacle.

FIG. 5 is a front view of the refuse receptacle lifter of FIGS. 4A and 4B in combination with a refuse receptacle.

FIG. 6 is a side view of a third embodiment of a refuse receptacle lifter of FIG. 1 in the extended position, with the refuse receptacle engagement mechanism engaging a refuse receptacle.

FIG. 7 is a side view similar to FIG. 6, with parts removed to show detail.

FIG. 8 is a perspective view of the first embodiment of a refuse receptacle lifter in combination with a refuse collection vehicle, the lifter being in the extended position with the refuse receptacle engagement mechanism engaging a refuse receptacle.

FIGS. 9-12 are sequential side views of the first embodiment of a refuse receptacle lifter in conjunction with a refuse collection vehicle and with the refuse receptacle engagement mechanism engaging a refuse receptacle showing the lifter moving from a generally extended position (FIG. 9) to a retracted, receptacle dumping position (FIG. 12).

FIGS. 13-15 are enlarged fragmentary side views of the lift arm and carriage for the refuse receptacle engagement mechanism, with the carriage at the lower arcuate portion of the lift arm (FIG. 13), the linear intermediate portion of the lift arm (FIG. 14), and the upper arcuate portion of the lift arm (FIG. 15).

FIG. 16 is an exploded perspective view of the refuse receptacle engagement mechanism and the lower end of the lift arm.

FIG. 17 is a perspective view of the third embodiment of a refuse receptacle lifter with the refuse receptacle in a substantially-inverted, refuse dumping position.

### DETAILED DESCRIPTION

The embodiments disclosed herein are for the purpose of providing an exemplary description of the present subject matter. They are, however, only exemplary, and the present subject matter may be embodied in various forms. Therefore, specific details disclosed herein are not to be interpreted as limiting the subject matter as defined in the accompanying claims.

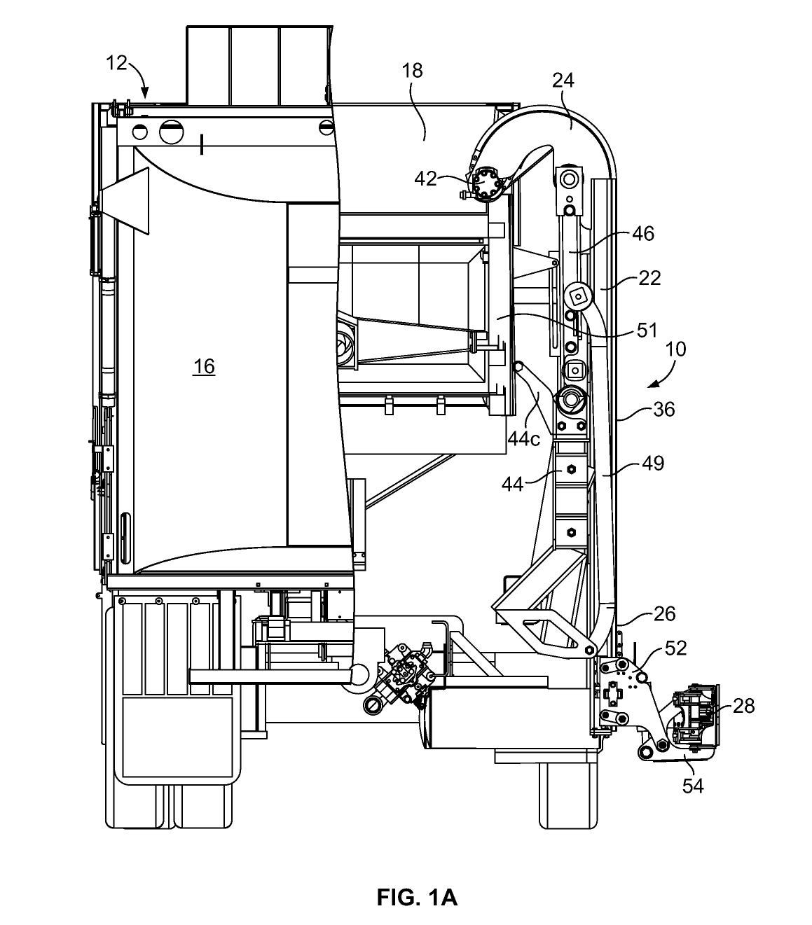

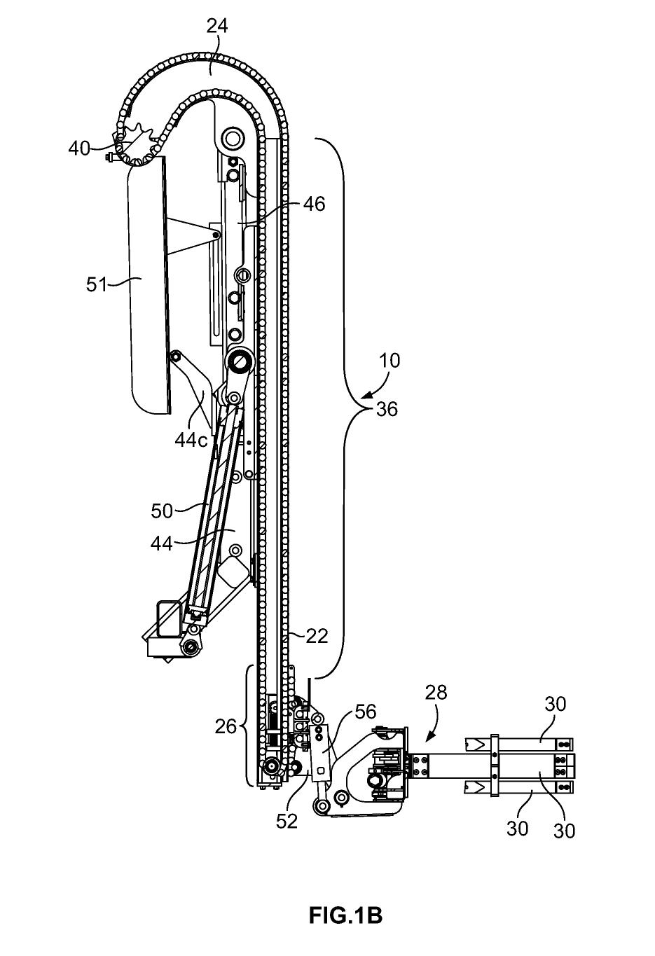

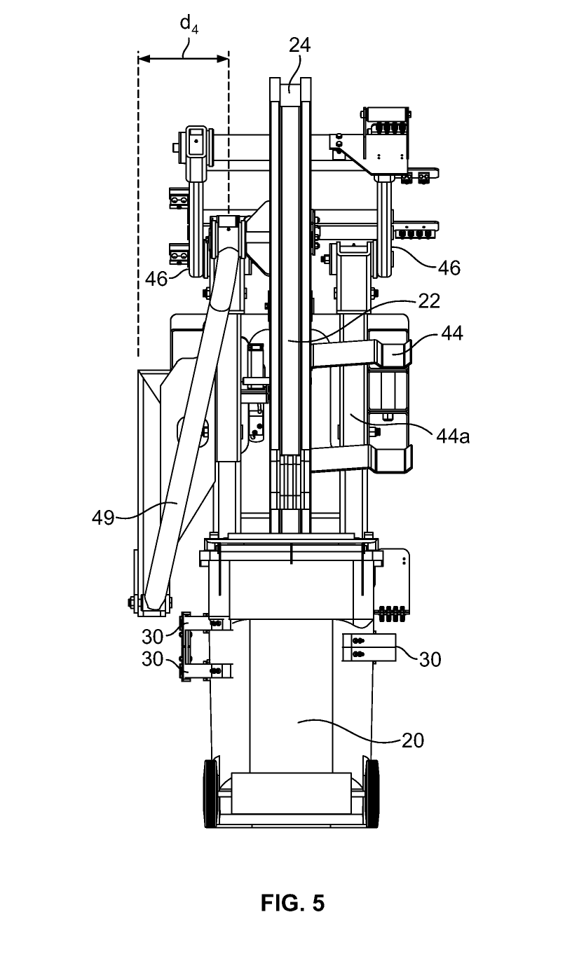

With reference to the drawings, there is seen a refuse receptacle lifter, generally designated 10, in accordance with the present disclosure. As best seen in FIGS. 1A and 5, the lifter 10 is secured to the side of a refuse collection vehicle 12 behind the vehicle cab 14. More particularly, the lifter 10 is secured to the sidewall of a hopper or collection container 16 that has an upper opening 18 through which refuse is dumped from a residential or curbside refuse receptacle 20 by means of the lifter 10. The illustrated lifter 10 has a number of parts that are movable relative to one another by means of one or more actuators. In the illustrated lifter, the actuators comprise hydraulically-powered piston and cylinder actuators, as is typical of refuse collection vehicles. However other types of actuators and power sources may be utilized without departing from the scope of the disclosure. The actuators are remotely controllable by the operator of the collection vehicle.

The lifter 10 includes an elongated lift arm 22, the upper end 24 of which is arcuate in shape, e.g., curving between about 120° and 150°, so that as a refuse receptacle moves along the arcuate upper end 24 of the lift arm 10 it is inverted for dumping. The lift arm 22 is movable relative to the collection container 16 between a retracted position, in which the lift arm has a generally vertical orientation (best seen in FIG. 1B), and a second extended position, in which the lower end 26 of the lift arm and the upper end 24, as needed, are spaced away from the collection container to engage or release a refuse receptacle.

A refuse receptacle engagement mechanism, generally designated 28, is secured to the lift arm 10 for movement between its lower end 26 and upper end 24. The engagement mechanism may take any of a number of configurations known for engaging and releasing curbside refuse receptacles. For purposes of illustration, the engagement mechanism 28 may comprise opposed gripper arms 30, which permit the grasping of a variety of styles of residential-type refuse receptacles, and also, when spread apart in oppositely extending directions, present a low profile when stowed. Preferably, the engagement mechanism may be as variously described in, e.g., U.S. Pat. No. 7,871,233, U.S. Pat. No. 7,390,159 or US 2005/0095097, each of which is incorporated by reference herein.

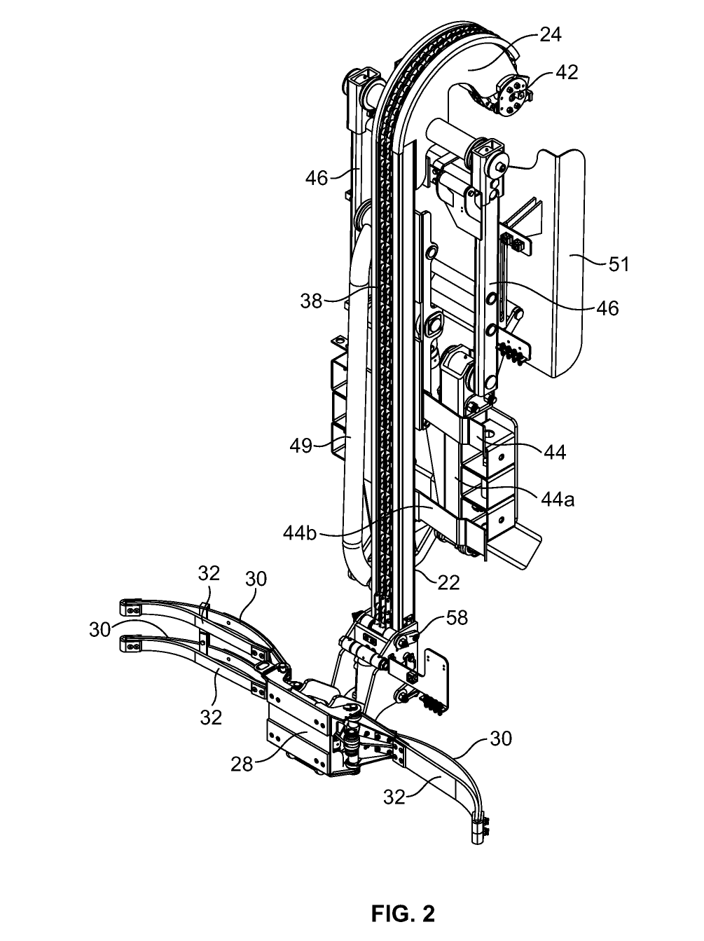

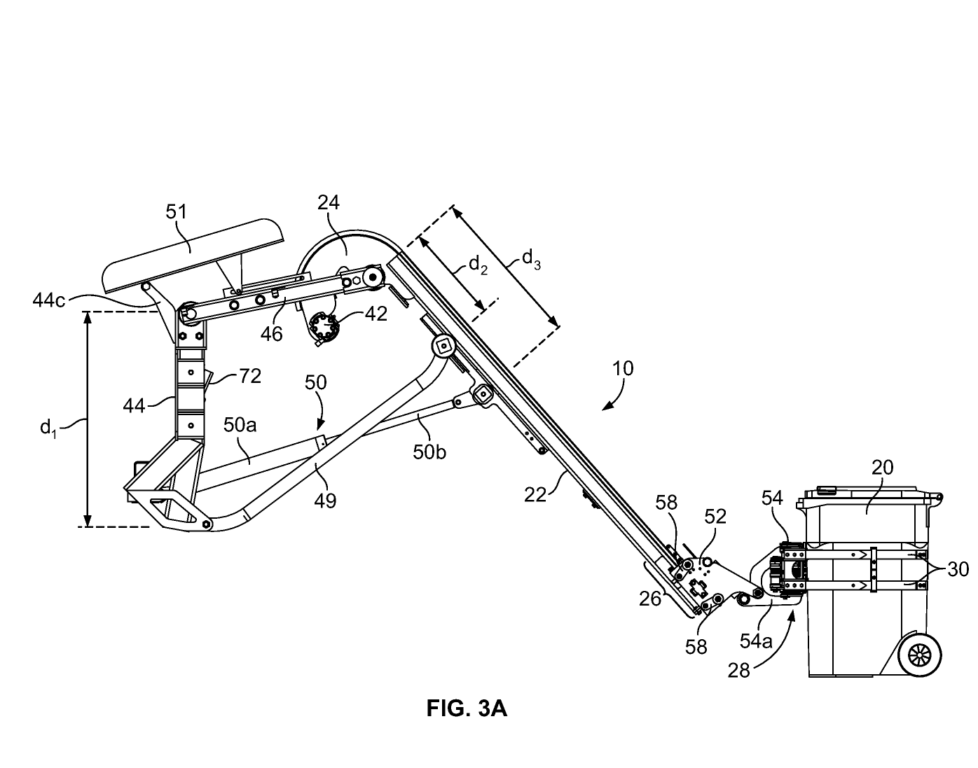

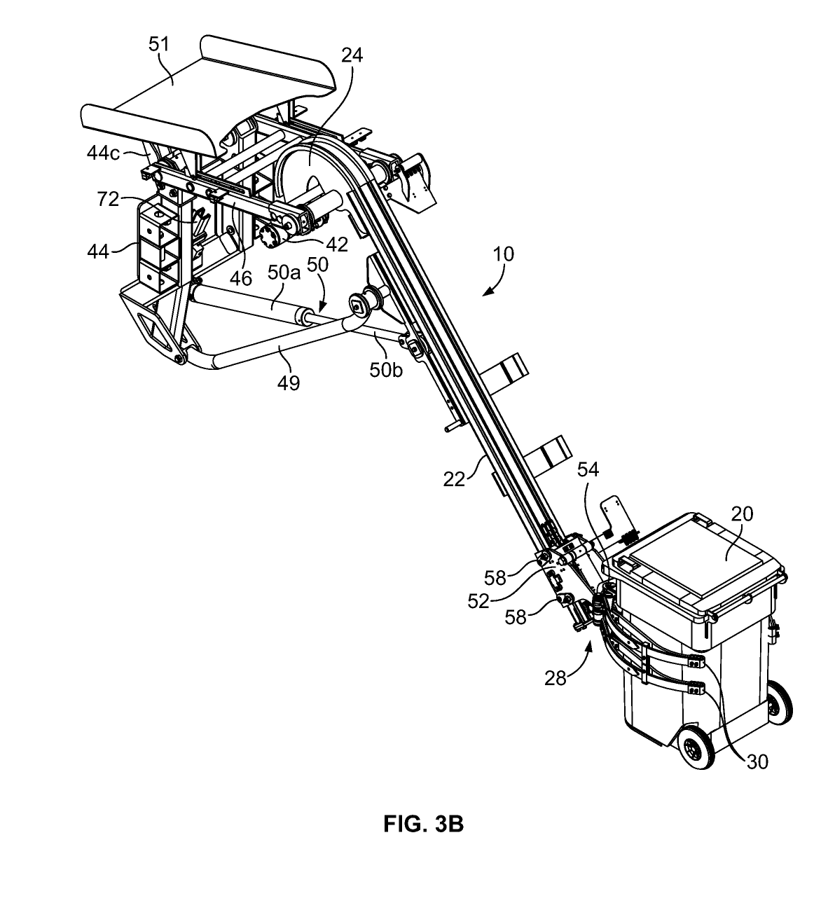

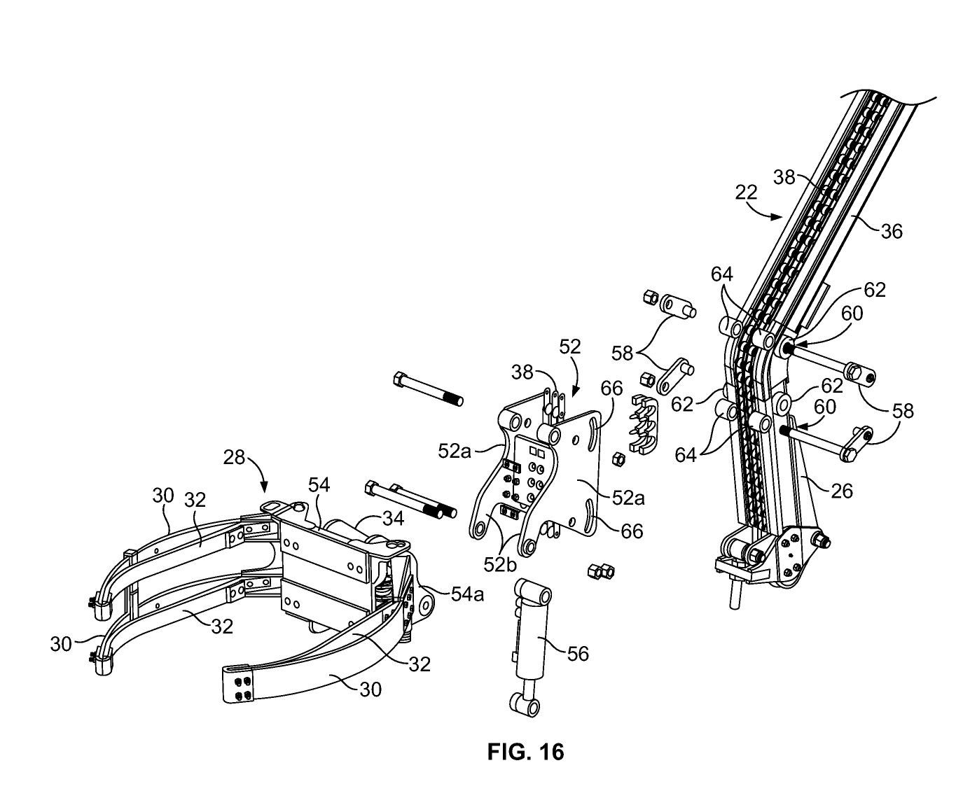

The gripper arms are movable between a first, open position (e.g., FIG. 2), and a second, closed or gripping position (e.g., FIGS. 3A and 3B), in which the gripper arms are able to securely grip a refuse receptacle 20 for retrieving, lifting and dumping. As illustrated, the gripper arms 30 may include tensioned straps 32 extending between the ends thereof that assist in gripping refuse receptacles by substantially conforming to the circumferential shape of the refuse container when the gripper arms 30 are in the closed position. Preferably, an hydraulically-operated actuator mechanism, generally designated 34 (best seen in FIG. 16), moves the gripper arms between the open and closed positions.

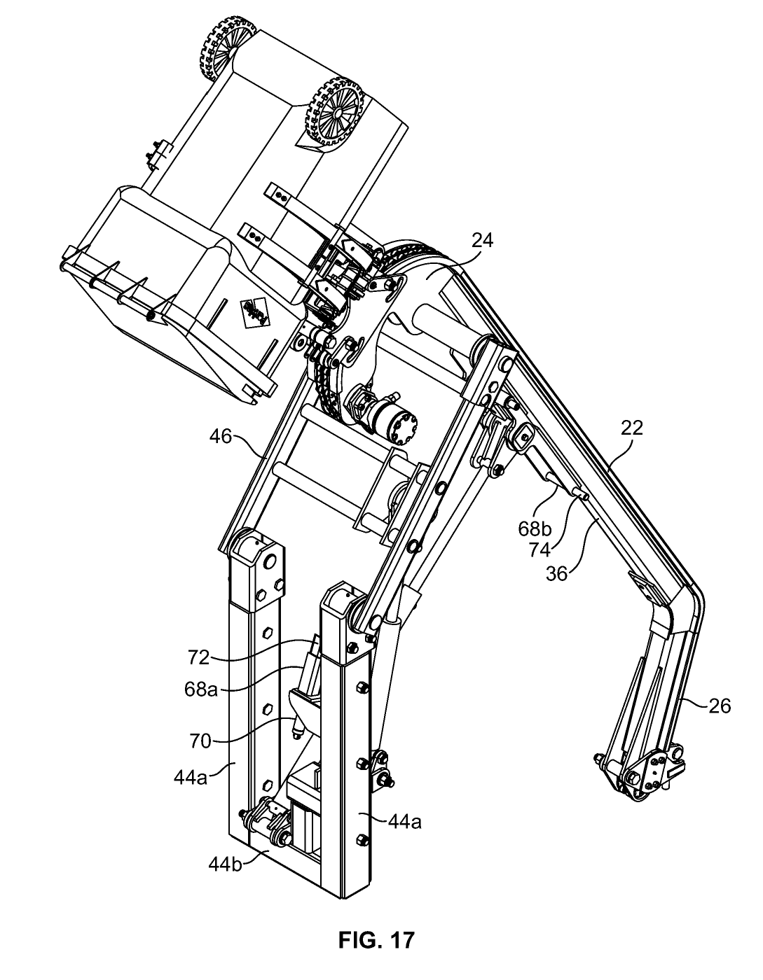

In keeping with the first aspect, the lifter 10 is mounted to the collection vehicle 12 for movement between the first, retracted position and the second extended position. To this end a mounting assembly, generally designated 44, is secured to the sidewall of the hopper or container 16. As illustrated, the mounting assembly comprises a plurality of structural members 44a and 44b (best seen in FIG. 17). An elongated link or drop arm 46 is pivotably connected on a first end to the mounting assembly 44, and pivotably connected on a second end to an upper portion of the lift arm 22. A second elongated link arm 49 is pivotally connected on a first end to the mounting assembly 44 below the pivotal connection of the first elongated link arm 46 to the mounting assembly 44, and is pivotally connected on a second end to the lift arm 22 between its upper and lower ends.

Preferably, the first and second link arms 46, 49 are of different lengths, the first ends of the link arms being spaced apart a first distance d₁ and the second ends of the link arms being spaced apart a second distance d₂ different from the first distance d₁, resulting in the link arms 46, 49 being non-parallel when the lifter is moved between the retracted and extended positions. Preferably, d₁ is greater than d₂. The mounting arrangement provides a modularity to the lifter, allowing it to be mounted on trucks or collection containers of a variety of shapes and sizes and allows it to be used in an after-market or retrofit application to convert existing vehicles for use with a high lifter as described herein, unlike some prior lifters, which require custom vehicle or lifter design for pairing together.

An extensible actuator 50, better seen in FIGS. 3A and 3B, is interposed between the mounting assembly 44 and the link arm 46 to pivot the link arm 46 between a retracted position, where the link arm 46 is substantially vertically aligned with the mounting assembly 44 in proximity to the sidewall of the hopper 16, and an extended position, in which the link arm 46 is angularly disposed relative to the mounting assembly 44, with the upper end 24 of the lift arm spaced laterally away from the sidewall of the hopper 16, extending the lateral reach of the lifter. Preferably, the first end of the actuator 50 is pivotally secured to the mounting assembly 44 intermediate the mounting locations of the first ends of the first and second link arms 46, 49, and the second end of the actuator 50 is spaced from the second end of the first link arm 46 a third distance d₃ that is greater than the second distance d₂. The provision of the link arms 46, 49 and the associated actuator 50 provide an extended lateral range for the lift arm, permitting the engagement mechanism 44 to engage and release refuse receptacles 20 that are spaced farther away from the collection vehicle and at different levels than would be the case with a typical high lifter mechanism, such as that disclosed in U.S. Pat. No. 5,702,225, discussed above, where the upper end of the lift arm is pivotally connected to the hopper and cannot extend laterally.

Optionally, the lifter may include a chute or deflector 51 (best seen in FIGS. 3A and 3B) movably mounted to the link arm 46. For example, the chute 51 may be pivotably secured to spaced-apart brackets 44c extending from the upper end of the mounting assembly 44. The chute moves between a retracted position, in which it is oriented substantially vertically, and a dumping position (as seen in FIGS. 3A and 3B), when the lift arm 22 is in its extended position, in which the chute is at a downward angle to guide refuse from an inverted receptacle into the interior of the collection container 16.

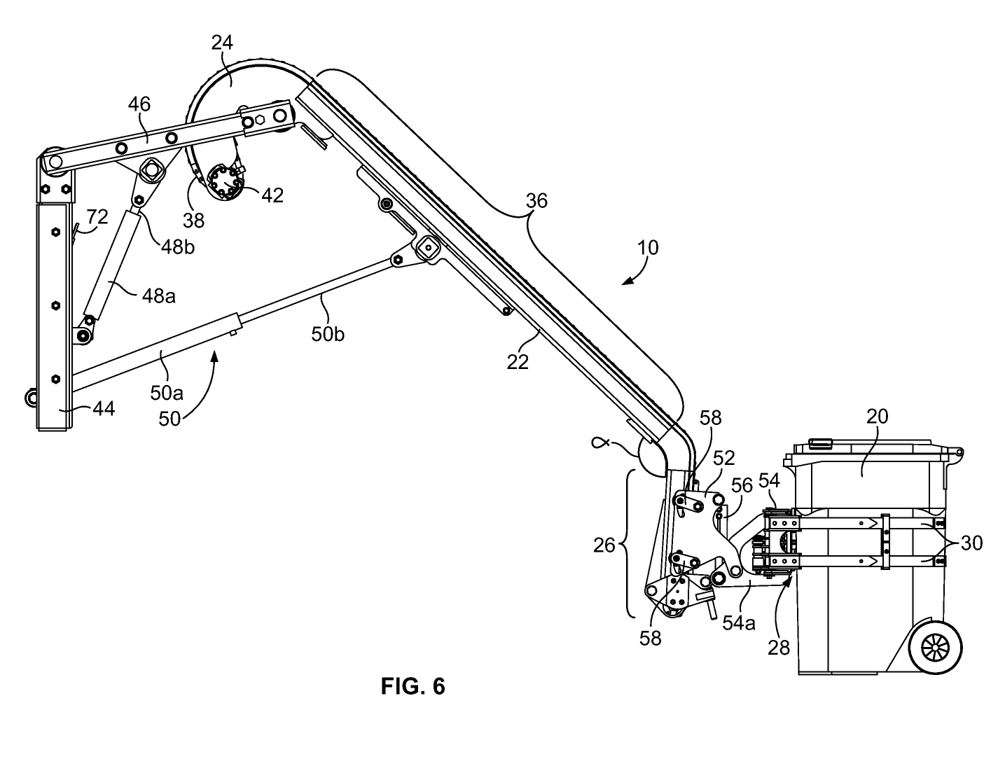

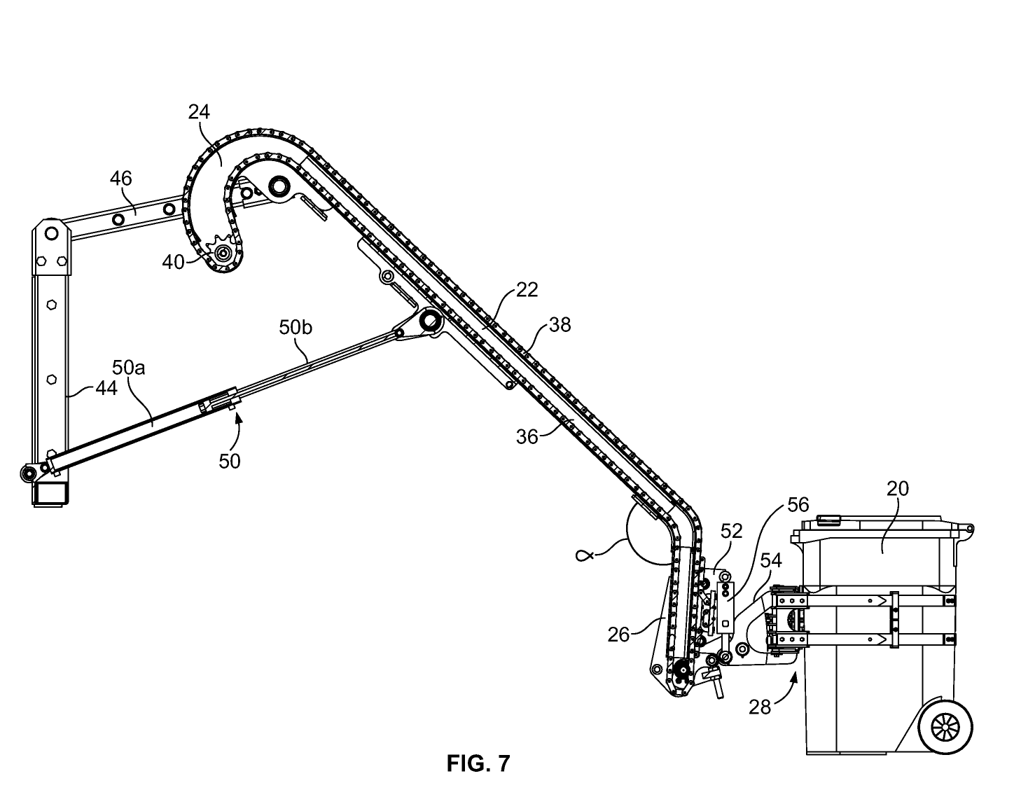

With reference to FIGS. 6 and 7, an alternative link arm/actuator configuration for moving the lift arm 22 between the retracted and extended positions is shown. In this embodiment, an additional actuator 48 is interposed between the mounting assembly 44 and the link arm 46 to pivot the link arm 46 between a retracted position, and an extended position, while the actuator 50 is interposed between the mounting assembly 44 and an intermediate portion of the lift arm 22 for moving the lift arm 22 between the retracted position and the extended position.

As illustrated, each of the actuators 48 and 50 comprises an elongated cylinder 48a, 50a and piston rod 48b, 50b. Preferably, the actuators 48, 50 are hydraulically powered. One end of the actuator 48 is pivotably connected to the mounting assembly 44 while the other end is pivotably connected to the link arm 46. Similarly, one end of the actuator 48 is pivotably connected to the mounting assembly 44 and the other end is pivotably connected to the lift arm 22. As illustrated, the cylinder 48a is pivotably connected to the mounting assembly 44, while the piston rod 48b is pivotably connected to the link arm 46; and the cylinder 50a is pivotably connected to the mounting assembly 44, while the piston rod 50b is pivotably connected to the lift arm 22.

When the lifter 10 is in the retracted, stowed or storage position, the piston rod 48b is substantially fully extended from its associated cylinder 48a, while the piston rod 50b is substantially fully retracted into its associated cylinder 50a. Conversely, when the lifter 10 is in its most extended position for engaging or releasing a curbside refuse receptacle, the piston rod 48b is substantially fully retracted into its associated cylinder 48a, while the piston rod 50b is substantially fully extended out of its associated cylinder 50a. This also provides great flexibility and versatility, as it allows for an infinite number of intermediate positions, accommodating a wide variety of collection cart heights and locations.

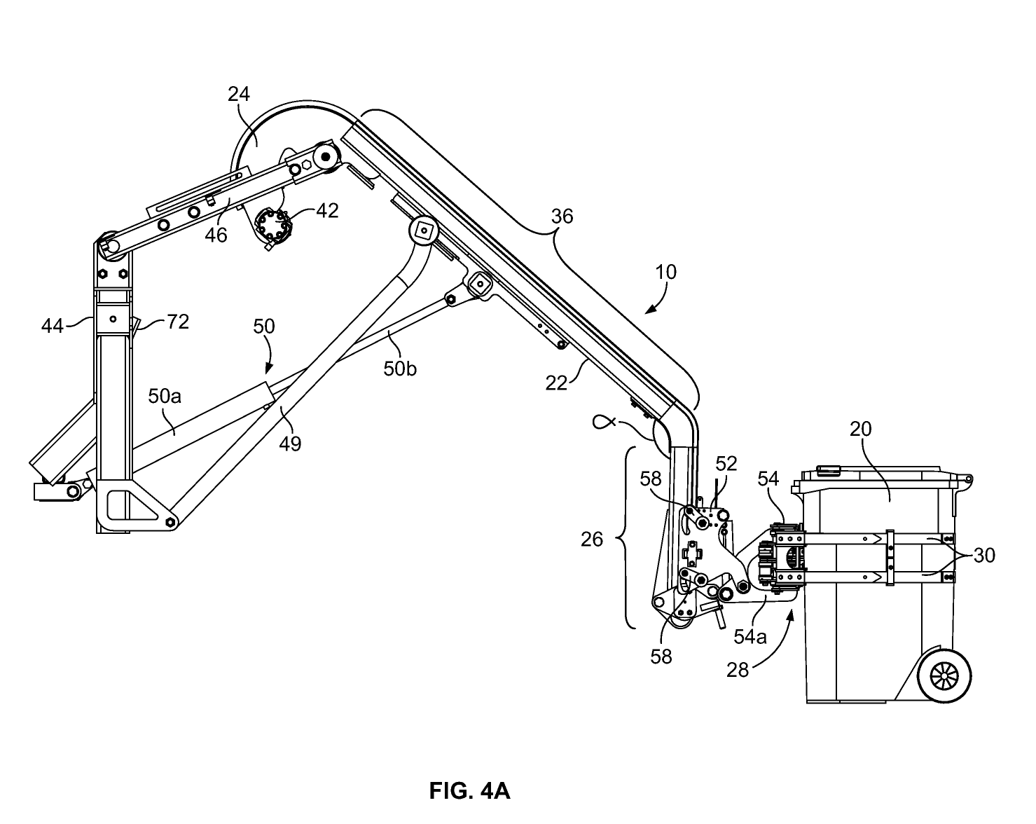

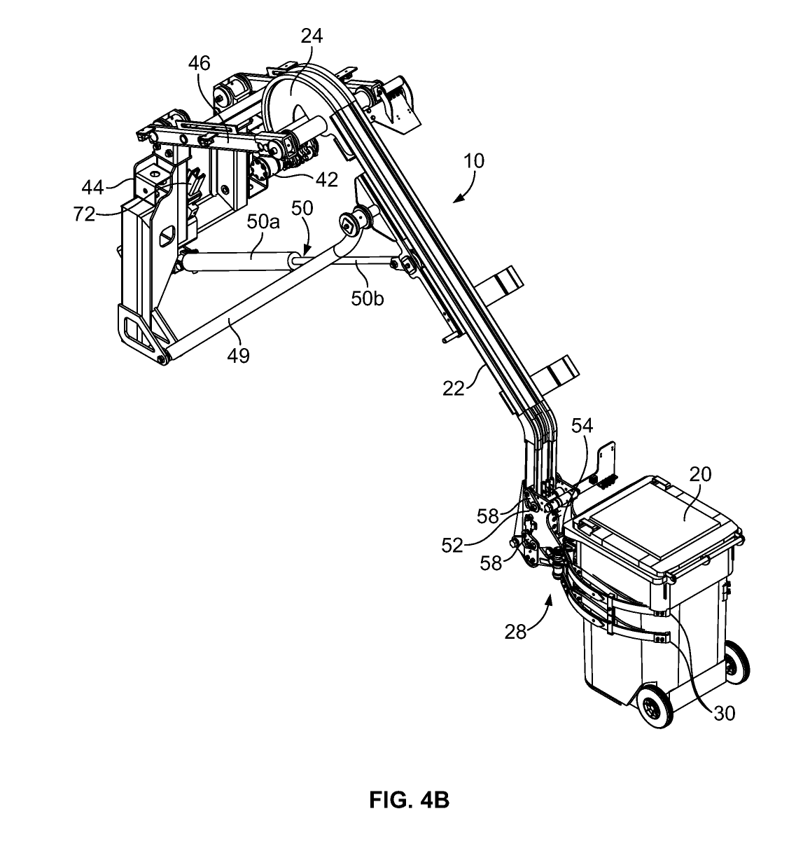

As seen in FIGS. 3A and 3B, the lift arm 22 has a substantially linear configuration from its upper end to its lower end. However, in keeping with a second, independent aspect of the disclosure, and with reference to FIGS. 4A, 6 and 7, the lift arm 22 includes an intermediate portion, generally designated 36 connecting the lower end 26 and upper arcuate portion 24 of the lift arm. Both the intermediate portion 36 and lower end portion 26 have a substantially linear configuration, with the lower end portion 26 being angularly offset or disposed relative to the intermediate linear portion 36 by an interior angle α. This angular offset results in the lower end 26 of the lift arm 22 being located beneath the arcuate upper end 24 when the lifter 10 is in the retracted position, and minimizes the extent to which the engagement mechanism 28 extends beyond the profile of the collection vehicle. It also may help to level the lifter in a generally horizontal position when the lower end 26 is extended for cart pick-up or release.

Preferably, the interior angle α between the lower linear portion 26 and the intermediate linear portion 36 is from between about 30° and 60°. In the illustrated embodiment, the interior angle α is approximately 40°. See, e.g., FIGS. 4A and 6.

As illustrated, the engagement mechanism 28 is moved between the lower and upper ends of the lift arm 10 by means of a drive chain, generally designated 38 movable in a track defined by the lift arm, the chain 38 extending around and engaging drive sprockets 40 (best seen in FIG. 1B) provided at the upper and lower ends of the lift arm. The sprockets 40 are rotated by a drive motor, generally designated 42, preferably secured to the upper end 24 of the lift arm 22. In the illustrated embodiment, the motor is hydraulically powered, although other types of motors may be used.

With reference to FIG. 5, where the lifter 10 has a single extensible actuator 50, with its lower end 26 angularly offset from the intermediate portion 36, the pivotal connection of the link arm 49 to the mounting assembly 44 may need to be laterally offset from the pivotal connection of the link arm 49 to the lift arm 22 in order to allow the lift arm 22 and link arm 49 to reside in a substantially vertical relation, and to accommodate the lower end 26, when in the retracted position.

In keeping with a third, independent aspect of the disclosure, the engagement mechanism 28 comprises a carriage 52 that is movably secured to the lift arm 22 for movement between the lower end 26 and upper end 24 thereof, and the engagement mechanism 28 is secured to a support 54 that is pivotably secured to the carriage 52. See, e.g., FIG. 16. As illustrated, the carriage 52 comprises a pair of side plates 52a extending therefrom that define arms 52b that are pivotably connected to supports in the form of brackets 54a that form part of the support 54.

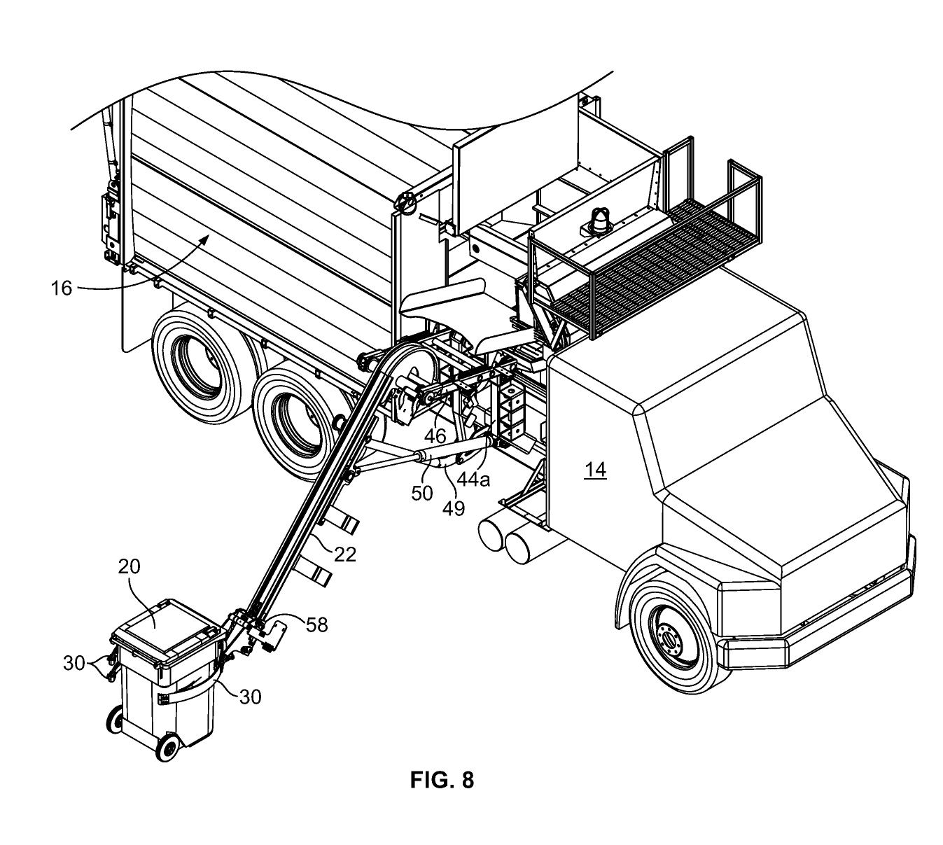

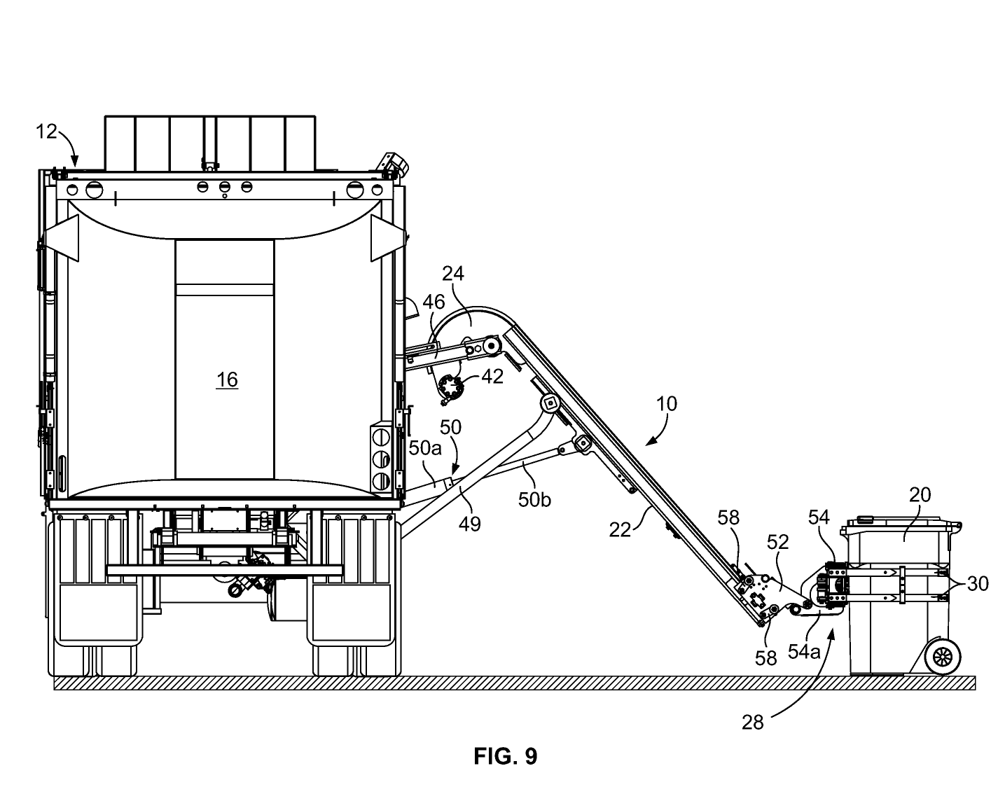

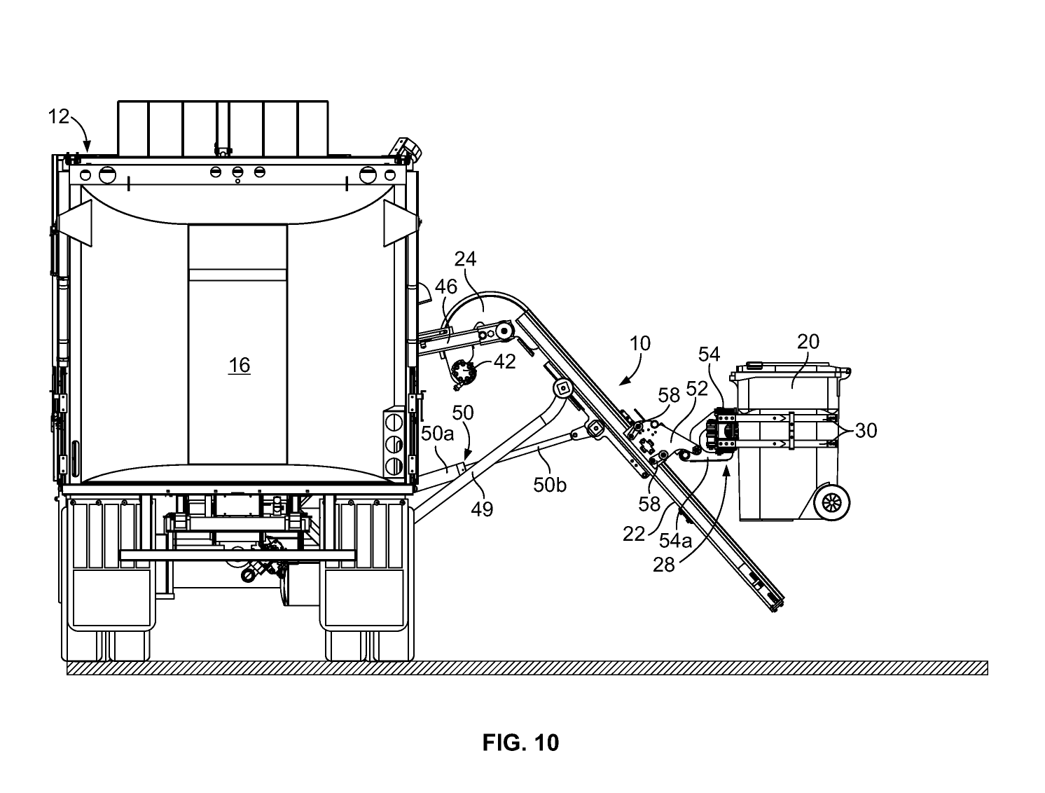

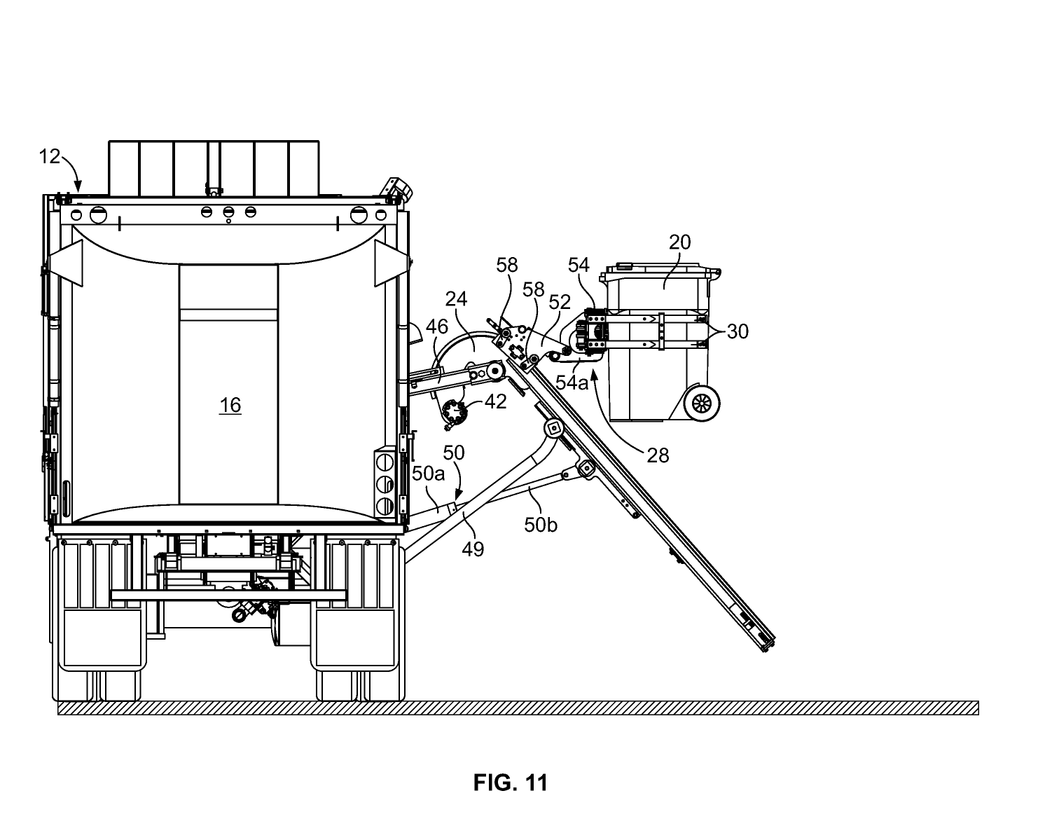

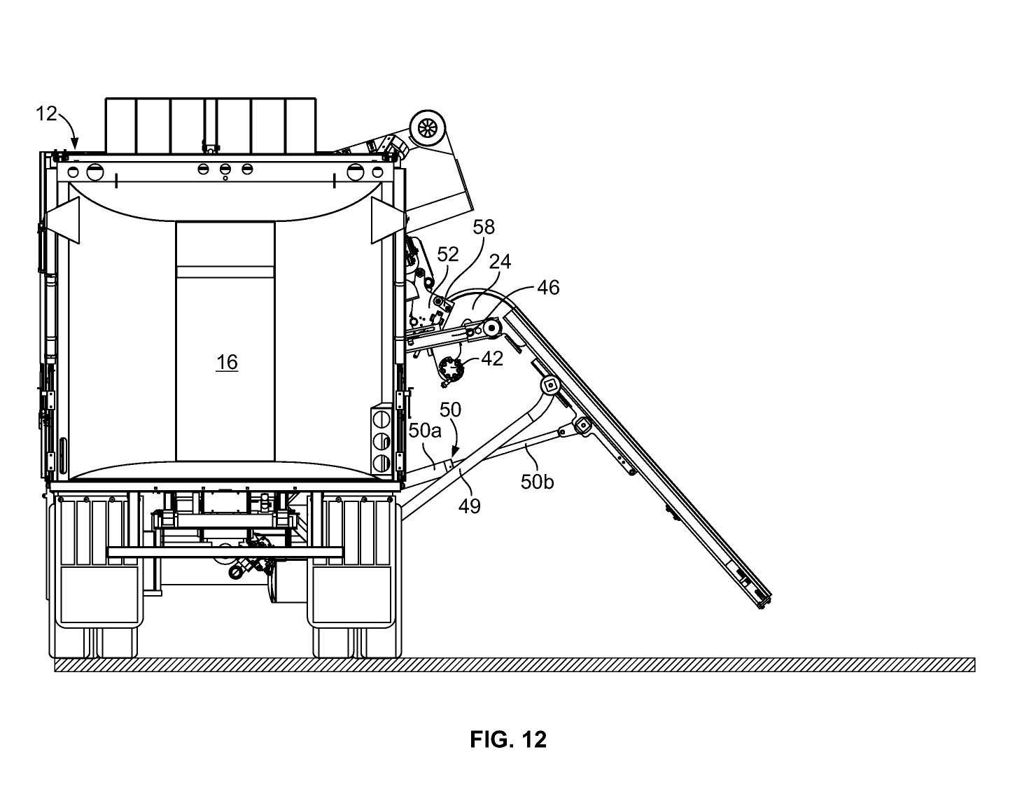

An actuator 56 is interposed between the carriage 52 and the engagement mechanism support 54 for pivoting the support relative to the carriage. This permits the curbside refuse receptacle or cart 20 to be kept substantially level as the carriage 52 moves between the lower end 26 and upper arcuate end 24 of the lift arm 22. See, e.g., FIGS. 6-10. This reduces the likelihood of the contents of the refuse receptacle 20 being inadvertently prematurely dumped as the receptacle moves along the lift arm 22. The actuator 56 may also be used to shake the refuse receptacle 20 when it is in position for dumping its contents into the hopper (FIG. 12), by oscillating the actuator 56 to pivot the support 54 back and forth relative to the carriage 52, to facilitate a more complete emptying of the receptacle 20 of its contents.

As illustrated, the actuator 56 comprises a piston 56a having a rod that extends out of a cylinder 56b, one of which is pivotably connected to the carriage 52, and the other is connected to the support 54. Preferably, the actuator is hydraulically powered.

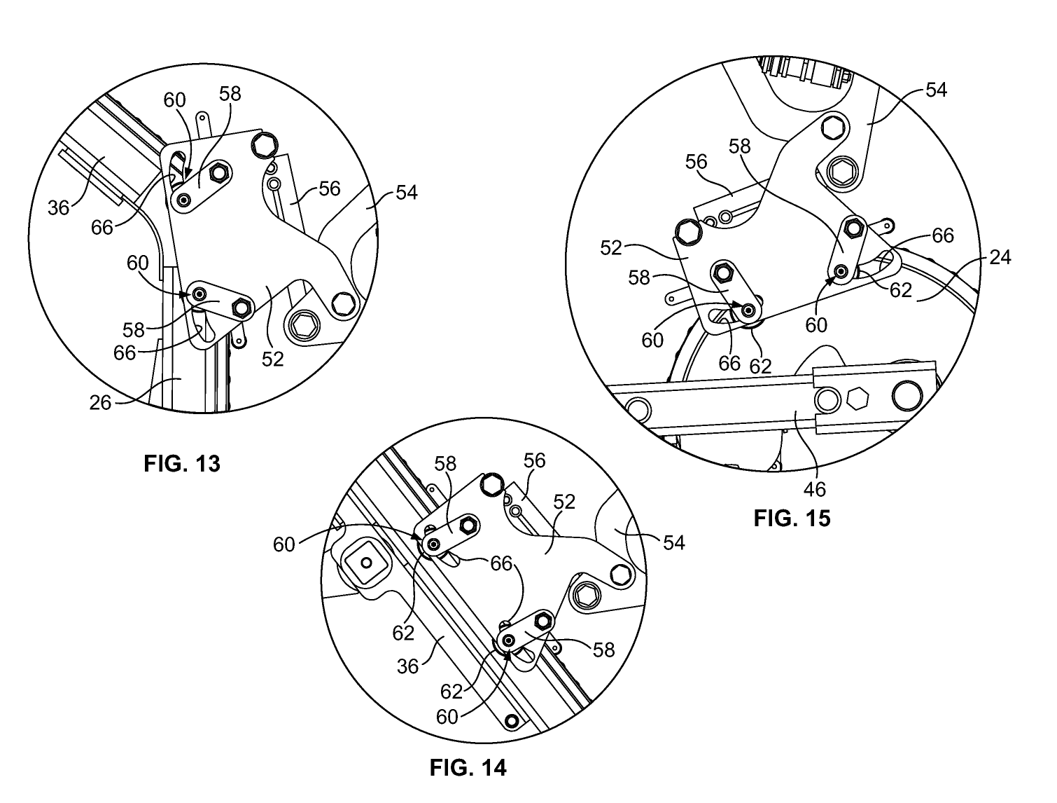

In keeping with a fourth, independent aspect, the carriage 52 is cooperatively associated with the track defined by the lift arm 22 by a plurality of links 58 that are each pivotably secured on one end to the carriage 52 and carry a follower, generally designated 60 and best seen in FIGS. 13-16, received in the track of the lift arm 22. As illustrated, the followers 60 comprise rollers or wheels 62 mounted to the free end of the links 58, so as to be freely rotatable relative thereto. With reference to FIGS. 13-15, the pivoting links 58 permit the wheels 62 to engage and follow the track of the lift arm 22 as the carriage 52 moves across the angular or arcuate transition between the lower and intermediate portions of the lift arm (FIG. 13), along the linear intermediate portion of the lift arm (FIG. 14), and along the upper arcuate portion of the lift arm (FIG. 15). Specifically, the pivoting of the links 58 allows the distance between the wheels 62 on adjacent links to vary, thus permitting the wheels 62 to follow the curvature of the track as the carriage moves along the lift arm 22. As best seen in FIG. 16, a second roller or wheel 64 is also associated with each link 58 at its pivot point, so that the wheels 62, 64 of each link capture the track of the lift arm 22 therebetween.

As illustrated, the free ends of the links 58 are captured in slots 66 in the side plates 52a of the carriage 52, the slots having an arcuate extent sufficient to accommodate the maximum and minimum distances between the wheels 62 as the carriage 52 moves along the lift arm 22. The arcuate extent of the slots is sufficient to permit the wheels 62 to engage the track of the lift arm 22 over both the upper arcuate portion 24 and an arcuate or angular lower portion of the lift arm 22 defined by the transition or bend connecting the lower end 26 of the lift arm to the intermediate portion 36 of the lift arm.

In keeping with a fifth, independent aspect of the disclosure, a remotely actuatable locking mechanism is provided for securing the lift arm in the retracted, substantially vertical position, with the lifter 10 in proximity to the sidewall of the hopper 16 (as seen in, e.g., FIGS. 1A, 1B and 2) for storage and during travel of the collection vehicle 12. As seen in FIG. 17, the locking mechanism comprises a first part 68a fixed relative to the collection container 16 that is selectively engagable with a second part 68b carried by the lift arm. More specifically, the first part 68a is secured to one of the structural members 44a comprising the mounting assembly 44, while the second part 68b is secured to an intermediate portion of the lift arm.

Preferably, the first part 68a of the locking mechanism comprises a cylinder and piston combination, generally designated 70. The rod of the piston extends outwardly from the cylinder and carries a capturing member 72 for engaging a complementarily-shaped captured member 74. As illustrated, the capturing member 72 comprises a generally U-shaped saddle, while the captured member 74 comprises a pin or rod that is engagable by or received in the saddle. Preferably, the locking mechanism is hydraulically actuated.

Thus, an improved automated side loading lift arm has been provided. It will be understood that the embodiments described above are illustrative of some of the applications of the principles of the present subject matter. Numerous modifications may be made by those skilled in the art without departing from the spirit and scope of the disclosure, specifically including those combinations of any one of the features that are individually disclosed herein with any or all of the other disclosed aspects. For these reasons, the scope hereof is not limited to the above description, but is set forth in the following claims.

1. A refuse receptacle lifter for use with a collection container, for example, a refuse collection vehicle, including an upper opening to receive refuse from a refuse receptacle, the lifter comprising:
a) an elongated lift arm including an arcuate upper end and a lower end, the lift arm being movable relative to the collection container between a first, generally vertically-extending retracted position in which the lift arm is in proximity to the collection container and a second, extended position in which the arcuate upper end and the lower end of the lift arm are spaced away from the collection container;
b) a refuse receptacle engagement mechanism secured to the lift arm for temporarily engaging a refuse collection container; the engagement mechanism being movable along the lift arm between a first position in proximity to the lower end of the lift arm for storage and for engaging and releasing a refuse receptacle and a second position in proximity to the upper arcuate end of the lift arm for emptying refuse from a refuse receptacle into the upper opening of the collection container;
c) wherein the lifter further comprises: a mounting assembly for mounting the lifter in cooperative association with the collection container; a first elongated link arm pivotally connected on a first end to the mounting assembly and pivotally connected on a second end to the lift arm; a second elongated link arm pivotally connected on a first end to the mounting assembly, the pivotal connection of the second elongated link arm to the mounting assembly being below the pivotal connection of the first elongated link arm to the mounting assembly, and the second elongated link arm being pivotally connected on a second end to the lift arm between the upper and lower ends; and an extensible actuator pivotally connected on a first end to the mounting assembly and pivotally connected on a second end to the lift arm for moving the lift arm between the first, retracted position and the second, extended position.

2. The lifter of claim 1 wherein the first and second link arms are of different lengths, the pivotal connections of the first ends of the link arms to the mounting assembly being spaced apart a first distance and the pivotal connections of the second ends of the link arms to the lift arm being spaced apart a second distance different from the first distance.

3. The lifter of claim 2 wherein the first distance is greater than the second distance.

4. The lifter of claim 2 wherein the first end of the actuator is pivotally secured to the mounting assembly intermediate the pivotal connections of the first ends of the first and second link arms, and the second end of the actuator is spaced from the pivotal connection of the second end of the first link arm a third distance greater than the second distance.

5. The lifter of claim 1 further comprising a collection container, the mounting assembly of the lifter being secured to a side of the collection container.

6. The lifter of claim 5 wherein the collection container is mounted to a refuse collection vehicle so that the lifter moves laterally from the refuse collection vehicle when moving between the first, retracted position and the second, extended position.

7. The lifter of claim 1 wherein the lift arm and second elongated link arm are offset to allow the lift arm and second link arm to reside in a substantially parallel side-by-side relation when the lift arm is in the first, retracted position.

8. The lifter of claim 1 wherein the lift arm comprises an upper arcuate portion defining the arcuate upper end, a lower linear portion defining the lower end, and an intermediate linear portion extending between the arcuate upper end and the lower linear portion, the lower linear portion being angularly disposed relative to the intermediate linear portion so that when the lift arm is in the first, retracted position, the lower end of the lift arm is generally located beneath the arcuate upper end of the lift arm.

9. The lifter of claim 8 wherein the intermediate linear portion and the lower linear portion are disposed relative to one another at a relative interior angle of from between about 30° and 60°.

10. The lifter of claim 1 further comprising a motor fixedly secured adjacent the upper end of the lift arm for moving the engagement mechanism between the first and second positions.

11. The lifter of claim 1 wherein the mounting assembly further comprises a chute movably secured on a second end to the first link arm so that the chute is movable between a first, substantially vertical retracted position and a second, deployed condition for guiding refuse being dumped from a receptacle into the collection container.

12. The lifter of claim 1 wherein the engagement mechanism further comprises a carriage movably secured to the lift arm for movement between the lower and upper ends thereof; an engagement mechanism support pivotally secured to the carriage; the engagement mechanism being mounted to the engagement mechanism support for movement between a first position for receiving and releasing a refuse receptacle and a second position for engaging the refuse receptacle; and an actuator interposed between the carriage and the engagement mechanism support for pivoting the engagement mechanism support relative to the carriage.

13. The lifter of claim 12 wherein the carriage comprises a pair of arms extending outwardly therefrom and the engagement mechanism support comprises a pair of supports, each arm being pivotally connected to a respective support.

14. The lifter of claim 1 wherein the lift arm comprises a track and the engagement mechanism further comprises a carriage movable along the track between the lower and upper ends of the lift arm; the carriage being cooperatively associated with the track by a plurality of links having first and second ends, the first end of each link being pivotally secured to the carriage and the second end of each link carrying a follower received in the track, sufficient pivotal movement of the links being permitted so that as the carriage moves along the arcuate end of the lift arm, the distance between the followers on adjacent links may vary to allow movement along the arcuate upper end of the lift arm.

15. The lifter of claim 14 wherein the followers comprise wheels mounted to the second end of each link so as to be freely rotatable with respect thereto.

16. The lifter of claim 14 wherein the carriage comprises opposed side plates, the first end of each link being pivotally mounted thereto, the side plates having a slot corresponding to each link mounted thereto, each slot cooperatively associated with the second end of each link to allow pivoting of the second end of the links relative to the first end.

17. The lifter of claim 16 wherein each slot is arcuately shaped and has an arcuate extent to permit the pivoting of the links so as to accommodate maximum and minimum distances between adjacent followers as the carriage moves along the lift arm.

18. The lifter of any one of claims 4 wherein the lifter includes an arcuate lower portion that has a different radius of curvature than the arcuate upper end and wherein the distance between the followers is sufficiently variable to allow movement of the carriage along the upper arcuate end and the lower arcuate portion.

19. The lifter of claim 1 further comprising a lock for selectively securing and releasing the lift arm when in the first, retracted position, the locking mechanism comprising a first part fixed relative to the mounting assembly and selectively engagable with a second part carried by the lift arm when the lift arm is in the first, retracted position.

20. A refuse receptacle lifter for use with a collection container, for example, a refuse collection vehicle, including an upper opening to receive refuse from a refuse receptacle, the lifter comprising:
a) an elongated lift arm including an arcuate upper end and a lower end, the lift arm being movable relative to the collection container between a first, generally vertically-extending retracted position in which the lift arm is in proximity to the collection container and a second, extended position in which the arcuate upper end and the lower end of the lift arm are spaced away from the collection container;
b) a refuse receptacle engagement mechanism secured to the lift arm for temporarily engaging a refuse collection container; the engagement mechanism being movable along the lift arm between a first position at the lower end of the lift arm for storage and for engaging and releasing a refuse receptacle and a second position at the upper arcuate end of the lift arm for emptying refuse from a refuse receptacle into the upper opening of the collection container;
c) wherein the lifter further comprises: a mounting assembly for mounting the lifter relative to the collection container; an elongated link arm pivotably connected on a first end to the mounting assembly and pivotably connected on a second end to an upper portion of the lift arm; a first extensible actuator interposed between the mounting assembly and the link arm for pivoting the link arm between retracted and extended positions; and a second extensible actuator interposed between the mounting assembly and the lift arm for moving the lift arm between the first, retracted position and the second, extended position.
